(19) United States
(12) Patent Application Publication
(10) Pub. No.: US 2025/0388019 A1
(43) Pub. Date: Dec. 25, 2025

(54) LIQUID CONTAINER AND INKJET RECORDING DEVICE INCLUDING SAME

(71) Applicant: KYOCERA Document Solutions Inc., Osaka (JP)

(72) Inventors: Yusuke TAMEKUNI, Osaka (JP); Shunsuke YAMASAKI, Osaka (JP); Shogo USUI, Osaka (JP); Yu SASAKI, Osaka (JP); Kohei YAMAKAMI, Osaka (JP); Naoto MIYASHITA, Osaka (JP)

(73) Assignee: KYOCERA Document Solutions Inc., Osaka (JP)

(21) Appl. No.: 19/245,973

(22) Filed: Jun. 23, 2025

(30) Foreign Application Priority Data
Jun. 24, 2024 (JP) 2024-101342

(51) Int. Cl. B41J 2/175; B41J 2/19

(52) U.S. Cl. CPC B41J 2/175; B41J 2/19

(57) ABSTRACT

A liquid container includes a main body portion having a bottom part and a side wall part, so as to store liquid in a containing region enclosed by the bottom part and the side wall part, a lid portion that covers the containing region from above, a liquid flow inlet that allows the liquid to flow into the containing region, a liquid flow outlet that allows the liquid to flow out from the containing region to a feed destination, and a bubble exhaust port that discharges bubbles in the containing region. The liquid flow inlet, the liquid flow outlet, and the bubble exhaust port are all disposed in the lid portion.

### INCORPORATION BY REFERENCE

This application is based upon and claims the benefit of priority from the corresponding Japanese Patent Application No. 2024-101342 filed Jun. 24, 2024, the entire contents of which are hereby incorporated by reference.

### BACKGROUND

The present disclosure relates to a liquid container and an inkjet recording device including the same.

The inkjet recording device forms an image using ink as liquid. In other words, the inkjet recording device allows the ink to flow in the device.

In a conventional inkjet recording device, the ink is temporarily stored in a liquid container. Then, the ink is fed from the liquid container to a recording head. The recording head ejects the ink fed from the liquid container to a sheet, so as to form an image made of ink on the sheet.

### SUMMARY

A liquid container according to a first aspect of the present disclosure is a liquid container disposed in a liquid flow path, and includes a main body portion, a lid portion, a liquid flow inlet, a liquid flow outlet, and a bubble exhaust port. The main body portion has a bottom part and a side wall part standing upward from the bottom part, so as to store liquid in a containing region defined as a region enclosed by the bottom part and the side wall part. The lid portion is attached to the main body portion so as to cover the containing region from above. The liquid flow inlet allows the liquid to flow into the containing region. The liquid flow outlet allows the liquid to flow out from the containing region to a feed destination. The bubble exhaust port discharges bubbles in the containing region. The liquid flow inlet, the liquid flow outlet, and the bubble exhaust port are all disposed in the lid portion.

An inkjet recording device according to a second aspect of the present disclosure includes the liquid container, an ink storage container configured to store ink, and a recording head. The liquid container stores ink flowing in from the ink storage container. The recording head forms an image on a sheet using the ink fed from the liquid container.

### BRIEF DESCRIPTION OF THE DRAWINGS

FIG. 1 is a schematic diagram of an inkjet recording device according to one embodiment.

FIG. 2 is a schematic diagram of a recording unit of the inkjet recording device according to one embodiment.

FIG. 3 is a schematic diagram of an ink feed system according to one embodiment.

FIG. 4 is a perspective view of a mini tank according to one embodiment, viewed from an upper side.

FIG. 5 is a perspective view of the mini tank according to one embodiment, viewed from a lower side.

FIG. 6 is a cross-sectional view of the mini tank according to the embodiment.

FIG. 7 is a diagram schematically illustrating flows of ink (containing bubbles) in the mini tank according to one embodiment.

FIG. 8 is a diagram illustrating plane positions of individual openings formed in a lid portion of the mini tank according to one embodiment.

### DETAILED DESCRIPTION

### <Structure of Inkjet Recording Device>

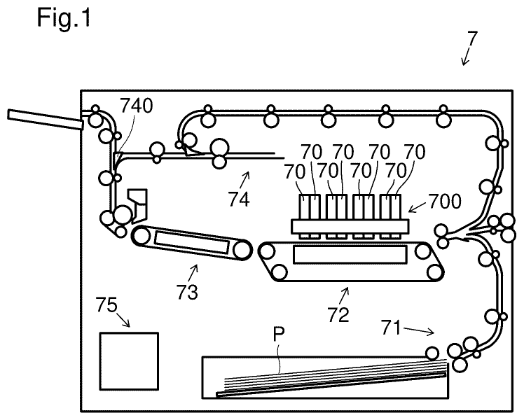

As illustrated in FIG. 1, an inkjet recording device 7 of this embodiment is an inkjet recording type printer. The inkjet recording device 7 forms (records) an image on a recording medium using ink. The ink corresponds to “liquid”. The recording medium is, for example, a paper sheet P (corresponding to a “sheet”). However, this is not a limitation, and various sheets such as a cloth sheet can be used as the recording medium.

The inkjet recording device 7 includes a recording unit 700. The recording unit 700 forms an image at a recording position. The recording unit 700 ejects the ink to the paper sheet P so as to form an image on the paper sheet P. In addition, the inkjet recording device 7 includes a paper feed unit 71, a first conveying unit 72 and a second conveying unit 73.

The paper feed unit 71 stores the paper sheets P, and sends out the paper sheet P one by one. The paper feed unit 71 conveys the paper sheet P to the recording position. The first conveying unit 72 and the second conveying unit 73 each have an endless belt disposed in a rotatable manner. Each of the first conveying unit 72 and the second conveying unit 73 sucks and holds the paper sheet P on the outer peripheral surface of the belt, and in this state, the belt is rotated. In this way, the paper sheet P is conveyed.

The recording unit 700 is positioned above the first conveying unit 72. The recording unit 700 forms an image on the paper sheet P that is being conveyed by the first conveying unit 72 (i.e., the paper sheet P on the belt). After the image is formed on the paper sheet P, the paper sheet P is sent from the first conveying unit 72 to the second conveying unit 73. While the second conveying unit 73 is conveying the paper sheet P, the image (i.e., ink) formed on the paper sheet P is dried.

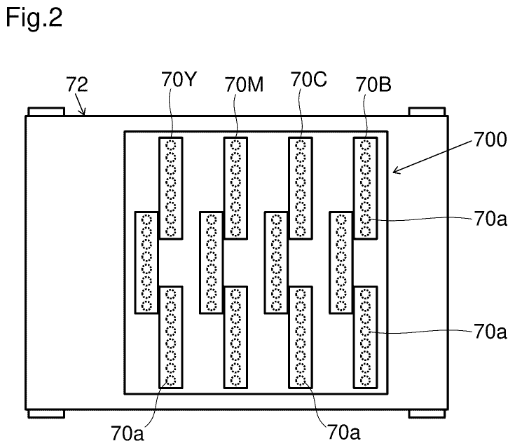

As illustrated in FIG. 2, the recording unit 700 includes three sets of recording heads 70B, 70C, 70M, and 70Y corresponding to black, cyan, magenta, and yellow colors. In the following description, suffix alphabets of the recording heads 70B, 70C, 70M, and 70Y are omitted if there is no need to distinguish them from each other.

Each of the recording heads 70 has a plurality of ink ejection nozzles 70a. Each of the recording heads 70 ejects ink to the paper sheet P on the first conveying unit 72. In this way, an image is formed on the paper sheet P.

Note that as illustrated in FIG. 1, the inkjet recording device 7 includes a reverse conveying unit 74. When forming images on both sides of the paper sheet P, after an image is formed on one side of the paper sheet P, a branch section 740 guides the paper sheet P to the reverse conveying unit 74. The reverse conveying unit 74 switchbacks the paper sheet P, and returns the paper sheet P to an upstream side of the recording position in a paper sheet conveying direction. In this way, the front and back sides of the paper sheet P are reversed. In other words, another image can be formed on the other side of the paper sheet P.

In addition, the inkjet recording device 7 includes a control unit 75. The control unit 75 includes various electronic components such as a processing circuit (a CPU and the like) and a memory. The control unit 75 controls operations of individual components of the inkjet recording device 7 on the basis of a control program and control data.

### <Structure of Ink Feed System>

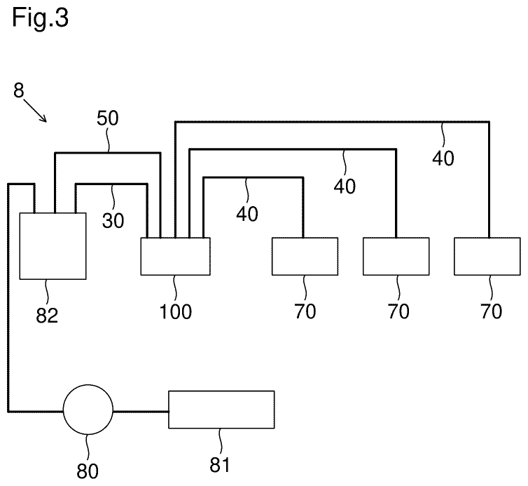

The inkjet recording device 7 includes an ink feed system 8 as illustrated in FIG. 3. Four ink feed systems 8 are disposed and assigned to black, cyan, magenta, and yellow colors. In other words, the ink feed systems 8 are assigned to the recording heads 70B, 70C, 70M, and 70Y, respectively.

Note that FIG. 3 only illustrates the ink feed system 8 of a certain color. The ink feed systems 8 of individual colors have the same structure. For this reason, descriptions of the ink feed systems 8 of other colors are omitted by referring to the following description.

The ink feed system 8 includes an ink container 81. The ink container 81 can be attached and detached from a main body of the inkjet recording device 7. The ink container 81 stores ink. When the inkjet recording device 7 forms an image on the paper sheet P, ink in the ink container 81 is used.

The ink feed system 8 includes a sub tank 82. The sub tank 82 corresponds to an “ink storage container”. For instance, a container pump 80 is disposed in an ink flow path between the ink container 81 and the sub tank 82. The container pump 80 sucks ink in the ink container 81 and discharges the ink to the sub tank 82.

The control unit 75 controls the container pump 80. For instance, the sub tank 82 includes an ink storage amount sensor (not shown) that outputs a value corresponding to an ink storage amount in the sub tank 82. As the ink storage amount sensor, it is possible to use various sensors such as an optical type, an electrostatic capacitance type, an electrode type, a differential pressure type, and a float type. The control unit 75 monitors an output value of the ink storage amount sensor. Further, if the ink storage amount in the sub tank 82 becomes less than a predetermined amount, the control unit 75 uses the container pump 80 to feed the ink from the ink container 81 to the sub tank 82.

The sub tank 82 temporarily stores the ink fed from the ink container 81. The recording head 70 is supplied with the ink from the sub tank 82. The positional relationship between the sub tank 82 and the recording head 70 is set so that an ink meniscus is formed at an opening of the ink ejection nozzle 70a on an ejecting side thereof. In other words, the ink is fed from the sub tank 82 to the recording head 70 by a water head pressure.

In addition, the ink feed system 8 includes a mini tank 100. The mini tank 100 corresponds to a “liquid container”. The mini tank 100 is disposed in the ink flow path between the sub tank 82 and the recording head 70. In other words, a feed destination of the ink flowing out from the mini tank 100 is the recording head 70.

The mini tank 100 suppresses a rapid pressure fluctuation in the ink flow path from the sub tank 82 to the recording head 70. In addition, the mini tank 100 branches the ink flow path into three. The single mini tank 100 feeds the ink to the three recording heads 70 that eject the same color ink.

### <Structure of Mini Tank>

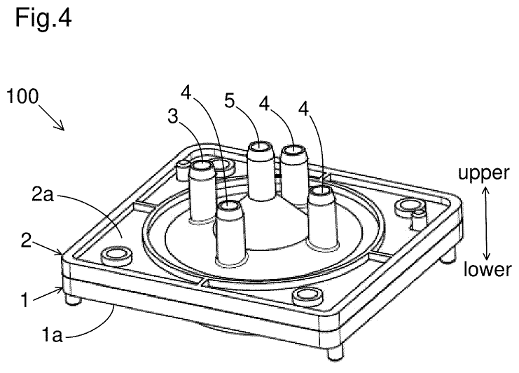

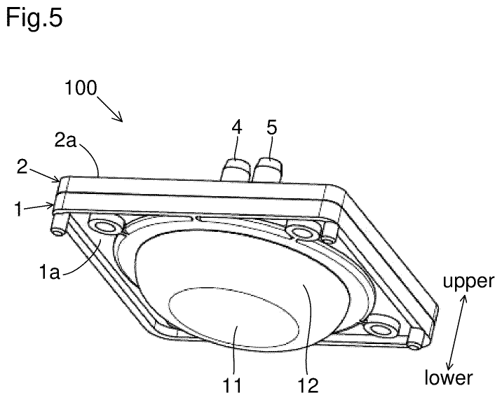

In this embodiment, the mini tank 100 illustrated in FIGS. 4 to 6 is used. The mini tank 100 has an up and down direction that is the vertical direction. The up and down direction of the mini tank 100 corresponds to an up and down direction of the inkjet recording device 7.

The mini tank 100 includes a main body portion 1 and a lid portion 2. The main body portion 1 and the lid portion 2 are each a resin molded product manufactured using a resin molding die. The main body portion 1 and the lid portion 2 are combined with each other so that the mini tank 100 is constituted. The main body portion 1 constitutes a lower portion of the mini tank 100, and the lid portion 2 constitutes an upper portion of the mini tank 100.

The main body portion 1 has a containing region 10 that stores ink. Specifically, the main body portion 1 has a bottom part 11 and a side wall part 12. The bottom part 11 has a circular shape when viewed in the up and down direction. The side wall part 12 stands upward from the bottom part 11 around the entire brim when viewed in the up and down direction. The main body portion 1 has the region enclosed by the bottom part 11 and the side wall part 12, as the containing region 10. The containing region 10 is the region having a circular shape when viewed in the up and down direction.

In the following description, the center of the containing region 10 when viewed in the up and down direction is denoted by CP, and a center axis passing through the center CP of the containing region 10 in the up and down direction is denoted by CA. In addition, a direction perpendicular to the center axis CA (i.e., the up and down direction) is referred to as a radial direction. In the radial direction, a direction approaching the center axis CA is referred to as inward in the radial direction, and a direction separating from the center axis CA is referred to as outward in the radial direction.

The lid portion 2 is disposed above the main body portion 1. The lid portion 2 covers the containing region 10 from above. In other words, the lid portion 2 closes an upper opening of the main body portion 1.

The lid portion 2 is attached to the main body portion 1. Specifically, the main body portion 1 has a main body side attachment part 1a that surrounds the side wall part 12 (i.e., the containing region 10), when viewed in the up and down direction. The main body side attachment part 1a has a contour having a substantially rectangular shape, when viewed in the up and down direction. The lid portion 2 has a lid side attachment part 2a that overlaps the main body side attachment part 1a in the up and down direction. The lid side attachment part 2a is fastened to the main body side attachment part 1a with a fastening member, and hence the lid portion 2 is combined with the main body portion 1.

The mini tank 100 includes an ink flow inlet 3 (corresponding to a “liquid flow inlet”). The ink flow inlet 3 is disposed in the lid portion 2. The ink flow inlet 3 is the same member as the lid portion 2. In other words, the lid portion 2 integrally includes the ink flow inlet 3.

The ink flow inlet 3 has an outer cylinder part 31 protruding upward from the lid portion 2 in a cylindrical manner. The outer cylinder part 31 has a cylindrical shape, and extends linearly in the up and down direction. The ink flow inlet 3 has an internal space of the outer cylinder part 31 as an ink flow passage.

The ink flow inlet 3 allows the ink to flow into the containing region 10 from the sub tank 82. Specifically, the ink flow inlet 3 is connected to a conduit 30 (see FIG. 3). The conduit 30 is attached to a distal end part of the outer cylinder part 31. The conduit 30 is connected to the sub tank 82, and allows the ink from the sub tank 82 to flow. In this way, the ink flows into the containing region 10 from the sub tank 82 through the conduit 30.

In addition, the mini tank 100 includes an ink flow outlet 4 (corresponding to a “liquid flow outlet”). The ink flow outlet 4 is disposed in the lid portion 2. The ink flow outlet 4 is the same member as the lid portion 2. In other words, the lid portion 2 integrally includes the ink flow outlet 4.

The ink flow outlet 4 has an outer cylinder part 41 protruding upward from the lid portion 2 in a cylindrical manner. The outer cylinder part 41 has a cylindrical shape and extends linearly in the up and down direction. The ink flow outlet 4 has an internal space of the outer cylinder part 41 as an ink flow passage.

The ink flow outlet 4 allows the ink to flow out from the containing region 10 to the recording head 70 (i.e., the feed destination of the ink). Note that the three recording heads 70 are assigned to each color. On the other hand, the single mini tank 100 is assigned to each color. For this reason, the mini tank 100 has the three ink flow outlets 4 corresponding to the three recording heads 70, respectively.

Each of the ink flow outlets 4 is connected to a conduit 40. The conduit 40 is attached to a distal end part of the outer cylinder part 41. Each of the ink flow outlets 4 allows the ink from the containing region 10 to flow out to the corresponding recording head 70 through the conduit 40. Each of the recording heads 70 forms an image using the ink fed from the mini tank 100.

In addition, the mini tank 100 includes a bubble exhaust port 5. The bubble exhaust port 5 is disposed in the lid portion 2. The bubble exhaust port 5 is the same member as the lid portion 2. In other words, the lid portion 2 integrally includes the bubble exhaust port 5.

The bubble exhaust port 5 has an outer cylinder part 51 protruding upward from the lid portion 2 in a cylindrical manner. The outer cylinder part 51 has a cylindrical shape and extends linearly in the up and down direction. The bubble exhaust port 5 has an internal space of the outer cylinder part 51 as a bubble flow passage.

The bubble exhaust port 5 discharges bubbles in the containing region 10 to the sub tank 82. Specifically, the bubble exhaust port 5 is connected to a conduit 50 (see FIG. 3). The conduit 50 is attached to a distal end part of the outer cylinder part 51. The conduit 50 is connected to the sub tank 82. In this way, the bubbles in the containing region 10 are discharged to the sub tank 82 through the conduit 50.

In this embodiment, because the bubbles in the containing region 10 can be discharged, the bubbles hardly flow into the recording head 70. Here, the recording head 70 forms an image using the ink, and if the bubbles flow into the recording head 70, an ink ejection error may occur in the recording head 70, resulting in quality deterioration of the image formed using the ink. For this reason, it is preferred to discharge the bubbles in the containing region 10.

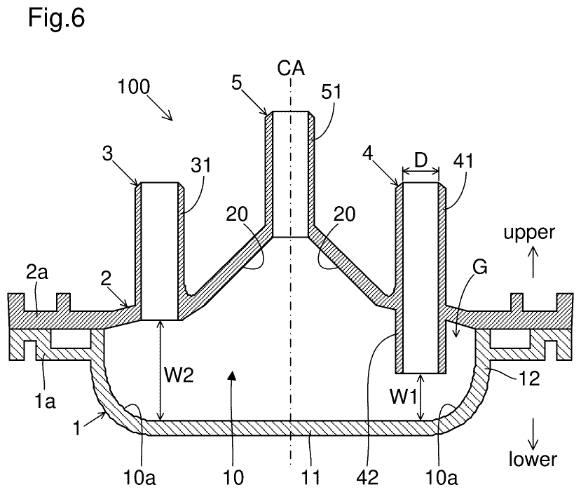

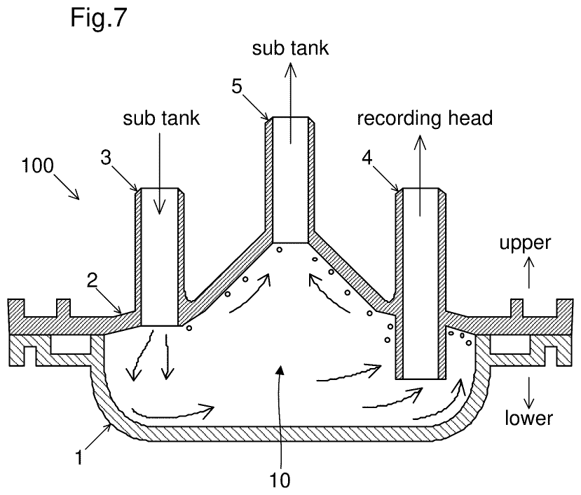

Flows of the ink (containing bubbles) in the containing region 10 is schematically illustrated in FIG. 7. FIG. 7 shows flows of the ink (containing bubbles) by arrows. In addition, the bubbles in the containing region 10 are shown by white small circles. Note that FIG. 7 does not show some reference numerals and symbols, by referring to them shown in FIG. 6.

### <Inner Cylinder Part of Ink Flow Outlet>

In this embodiment, as illustrated in FIG. 6, the ink flow outlet 4 has an inner cylinder part 42. The inner cylinder part 42 protrudes downward from the lid portion 2 in a cylindrical manner, and is disposed in the containing region 10. The inner cylinder part 42 has a cylindrical shape and extends linearly in the up and down direction. The ink flow outlet 4 has, in addition to the internal space of the outer cylinder part 41, an internal space of the inner cylinder part 42 as the ink flow passage. In other words, the internal space of the inner cylinder part 42 is communicated to the internal space of the outer cylinder part 41. In still other words, the ink flow outlet 4 has a cylindrical shape penetrating the lid portion 2 in the up and down direction.

In this way, the ink in the containing region 10 flows into the internal space of the inner cylinder part 42 through a lower end opening of the inner cylinder part 42 (i.e., an opening of the ink flow outlet 4 on the containing region 10 side). Then, the ink in the containing region 10 flows out from an upper end opening of the outer cylinder part 41 (i.e., an opening of the ink flow outlet 4 on the side opposite to the containing region 10 side).

Here, in this embodiment, the inner cylinder part 42 does not contact the side wall part 12 of the main body portion 1. In other words, there is a gap space G between the inner cylinder part 42 and the side wall part 12 in the radial direction. In still other words, the inner cylinder part 42 is disposed at a position with a space from an inner surface of the side wall part 12 inward in the radial direction.

In this structure, even if bubbles in the containing region 10 flow toward the ink flow outlet 4, the bubbles pass by the lower end opening of the inner cylinder part 42 and reaches the gap space G (see FIG. 7). As the bubbles in the containing region 10 moves to an upper position, the bubbles in the gap space G hardly flow into the ink flow outlet 4 (i.e., the lower end opening of the inner cylinder part 42). As a result, it is possible to prevent the bubbles from flowing out from the ink flow outlet 4. In other words, it is possible to prevent the bubbles from flowing into the recording head 70 as the feed destination of the ink.

As the bubbles are prevented from flowing into the recording head 70, it is possible to prevent an occurrence of the ink ejection error in the recording head 70. In this way, it is possible to prevent quality deterioration of the image formed using the ink.

In addition, in this embodiment, as the ink flow outlet 4 has the inner cylinder part 42, the opening of the ink flow outlet 4 on the containing region 10 side (i.e., the lower end opening of the inner cylinder part 42) is disposed closer to the bottom part 11 than the opening of the ink flow inlet 3 on the containing region 10 side. In other words, a distance W1 between the opening of the ink flow outlet 4 on the containing region 10 side and the bottom part 11, in the up and down direction, is smaller than a distance W2 between the opening of the ink flow inlet 3 on the containing region 10 side and the bottom part 11 in the up and down direction.

In this structure, the bubbles around the opening of the ink flow inlet 3 on the containing region 10 side hardly reach the opening of the ink flow outlet 4 on the containing region 10 side (i.e., the lower end opening of the inner cylinder part 42). In other words, the bubbles move upward while moving from the ink flow inlet 3 to the ink flow outlet 4, and hence the bubbles hardly flow into the ink flow outlet 4 (i.e., the lower end opening of the inner cylinder part 42). As a result, it is possible to prevent the bubbles from flowing out from the ink flow outlet 4.

For instance, the distance W1 between the opening of the ink flow outlet 4 on the containing region 10 side (i.e., the lower end opening of the inner cylinder part 42) and the bottom part 11, in the up and down direction, is set to be more than or equal to inner diameter D of the ink flow outlet 4. In this way, a flow resistance of the ink can be reduced.

As a modified example, the ceiling of the containing region 10 (i.e., the lower surface of the lid portion 2) may have a height difference. Further, it may be possible that the ink flow inlet 3 is disposed at a higher part of the ceiling, and that the ink flow outlet 4 is disposed at a lower part of the ceiling (i.e., a part of the lid portion 2 closer to the bottom part 11). With this structure, too, the opening of the ink flow outlet 4 on the containing region 10 side can be disposed at a position closer to the bottom part 11 than the opening of the ink flow inlet 3 on the containing region 10 side.

### <Height Positions of Ink Flow Inlet, Ink Flow Outlet, and Bubble Exhaust Port>

In this embodiment, as illustrated in FIG. 6, among the ink flow inlet 3, the ink flow outlet 4, and the bubble exhaust port 5, the position of the ink flow outlet 4 in the up and down direction is closest to the bottom part 11, and the position of the bubble exhaust port 5 in the up and down direction is farthest from the bottom part 11. In other words, an opening of the bubble exhaust port 5 on the containing region 10 side is at a position farther from the bottom part 11 than the opening of the ink flow inlet 3 on the containing region 10 side.

In this structure, the bubble exhaust port 5 is disposed at a position of the containing region 10 where the bubbles are apt to accumulate (i.e., the highest position). In this way, the bubbles in the containing region 10 can be efficiently discharged from the bubble exhaust port 5. As the bubbles are efficiently discharged from the bubble exhaust port 5, the bubble can be prevented from flowing into the ink flow outlet 4.

### <Plane Positions of Ink Flow Inlet, Ink Flow Outlet, and Bubble Exhaust Port>

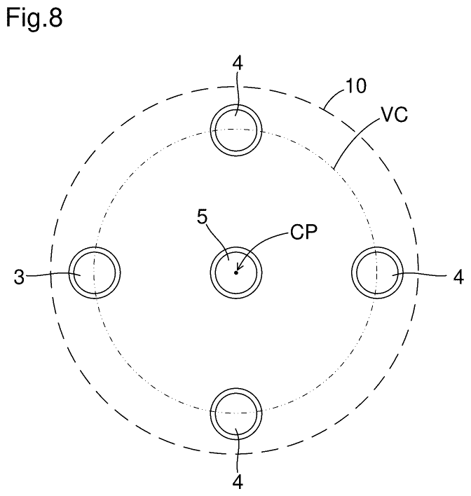

In this embodiment, as illustrated in FIG. 8, the total four openings that include the one ink flow inlet 3 and the three ink flow outlets 4 are disposed on an imaginary circle VC whose center is the center CP of the containing region 10, with equal intervals when viewed in the up and down direction. As there are four openings, they are disposed with intervals of 90 degrees in the circumferential direction of the imaginary circle VC. Although not illustrated, for example, if there are the one ink flow inlet 3 and the two ink flow outlets 4 (there are total three openings), they are disposed with intervals of 120 degrees in the circumferential direction of the imaginary circle VC.

Note that in FIG. 8, the imaginary circle VC is shown by a two-dot-dash line. In addition, the contour of the containing region 10 when viewed in the up and down direction is shown by a broken line.

In this structure, when viewed in the up and down direction, the openings in the lid portion 2 (the one ink flow inlet 3 and the three ink flow outlets 4) are distributed. In this way, the ink flowing into the containing region 10 from the ink flow inlet 3 can be appropriately stirred before reaching the ink flow outlets 4.

As the ink is stirred, the bubbles can easily move upward. In other words, the bubbles can easily move to the bubble exhaust port 5. In this way, discharge of bubbles from the bubble exhaust port 5 is promoted, and the bubbles are prevented from flowing into the ink flow outlet 4 (i.e., the bubbles are prevented from flowing out from the ink flow outlet 4). As a result, the bubbles are prevented from flowing into the recording head 70 as the feed destination of the ink.

In addition, in this structure, the ink in the containing region 10 is appropriately stirred, and hence the ink in the containing region 10 is prevented from increasing viscosity. In this way, it is possible to prevent high viscosity ink from flowing out from the ink flow outlet 4. As a result, it is possible to prevent high viscosity ink from flowing into the recording head 70 as the feed destination of the ink.

Because the bubbles are prevented from flowing into the recording head 70, and because the ink flowing into the recording head 70 is prevented from increasing viscosity, it is possible to prevent an occurrence of the ink ejection error in the recording head 70. In this way, it is possible to prevent quality deterioration of the image formed using the ink.

In addition, in this embodiment, the bubble exhaust port 5 is disposed at a position in the lid portion 2 overlapping the center CP of the containing region 10 (i.e., the center CP of the imaginary circle VC), when viewed in the up and down direction. In this way, the bubbles can be efficiently collected at the bubble exhaust port 5. As a result, the bubbles can be efficiently discharged from the bubble exhaust port 5.

In addition, in this embodiment, the ink flow inlet 3 is disposed at a position in the lid portion 2 apart from the position overlapping the side wall part 12 to the containing region 10 side (i.e., inward in the radial direction), when viewed in the up and down direction. In this way, the lid portion 2 has the shape illustrated in FIG. 4. In other words, the lid portion 2 can be easily molded of resin.

### <Shape of Main Body Portion>

In this embodiment, as illustrated in FIG. 6, a corner part 10a of the containing region 10, constituted of the bottom part 11 and the side wall part 12, has an R-shaped inner surface at least partially. In other words, the corner part 10a of the containing region 10 has a curved inner surface at least partially.

In this structure, it is possible to prevent the ink from staying at the corner part 10a of the containing region 10, and hence stirring of the ink is promoted. As a result, the ink in the containing region 10 is prevented from increasing viscosity. As the ink in the containing region 10 is prevented from increasing viscosity, it is possible to prevent high viscosity ink from flowing out from the ink flow outlet 4 (i.e., it is possible to prevent high viscosity ink from flowing into the recording head 70 as the feed destination of the ink). In addition, as stirring of the ink is promoted, it is possible to prevent bubbles from flowing out from the ink flow outlet 4 (i.e., it is possible to prevent bubbles from flowing into the recording head 70 as the feed destination of the ink).

Note that in this embodiment, the corner part 10a of the containing region 10 is formed to have an R-shape around the entire circumference surrounding the containing region 10. In this way, stirring of the ink in the containing region 10 can be promoted more.

Here, in this embodiment, when viewed in the up and down direction, at least a part of the ink flow inlet 3 is overlapped with the R-shaped corner part 10a of the containing region 10. In this structure, the ink flowing in through the ink flow inlet 3 flows toward the R-shaped corner part 10a. In this way, the ink can be easily stirred in the containing region 10.

In addition, in this embodiment, when viewed in the up and down direction, at least a part of the ink flow outlet 4 is overlapped with the R-shaped corner part 10a of the containing region 10. In this structure, the ink can be easily stirred in the R-shaped corner part 10a just before flowing out from the ink flow outlet 4.

As a modified example, although not illustrated, the corner part 10a of the containing region 10 may be formed to have an R-shape only partly. For instance, in the corner part 10a of the containing region 10, only the part that overlaps the ink flow inlet 3 at least partially may be formed to have an R-shape, or only the part that overlaps the ink flow outlet 4 at least partially may be formed to have an R-shape.

### <Shape of Lid Portion>

In this embodiment, as illustrated in FIG. 6, the lower surface of the lid portion 2 has an inclined surface 20. The inclined surface 20 of the lid portion 2 is inclined upward toward the inside in the radial direction. In other words, the lower surface of the lid portion 2 defining the containing region 10 has the inclined surface 20, which is inclined upward toward the center CP (the center axis CA) of the containing region 10.

Here, when viewed in the up and down direction, the bubble exhaust port 5 is disposed at a position overlapping the center CP, while the ink flow inlet 3 and the ink flow outlets 4 are disposed at positions outward in the radial direction with respect to the bubble exhaust port 5. In this way, the lower surface of the lid portion 2 is inclined upward from positions of the ink flow inlet 3 and the ink flow outlets 4 toward the position of the bubble exhaust port 5 in the lid portion 2.

In this structure, bubbles in the containing region 10 can easily move along the inclined surface 20 of the lid portion 2. In other words, the bubbles in the containing region 10 can easily move to the bubble exhaust port 5. In this way, the bubbles can be easily discharged from the bubble exhaust port 5.

### <Directions of Ink Flow Inlet, Ink Flow Outlet, and Bubble Exhaust Port>

In this embodiment, the ink flow inlet 3, the ink flow outlet 4, and the bubble exhaust port 5 are all disposed in the lid portion 2. Specifically, the ink flow inlet 3, the ink flow outlet 4, and the bubble exhaust port 5 have the outer cylinder parts 31, 41, and 51, respectively. Each of the outer cylinder parts 31, 41, and 51 has the internal space thereof as the ink flow passage. Each of the outer cylinder parts 31, 41, and 51 protrudes upward from the lid portion 2 in a cylindrical manner. In other words, the outer cylinder parts 31, 41, and 51 protrude in the same direction. The conduits 30, 40, and 50 that allow the ink to flow inside are attached to the outer cylinder parts 31, 41, and 51, respectively.

In this structure, the conduits 30, 40, and 50 are intensively attached to the upper side of the mini tank 100. In this way, flexibility of placement of the mini tank 100 can be enhanced. In other words, other members can be disposed on the lower side of the mini tank 100. In still other words, an extra space around the mini tank 100 can be reduced. As a result, the inkjet recording device 7 including the mini tank 100 can be downsized.

The embodiment disclosed this time is an example in every aspect, and should not be interpreted as a limitation. The scope of the present disclosure is defined not by the above description of the embodiment but by the claims, and includes all modifications within meaning and scope equivalent to the claims.

What is claimed is:

1. A liquid container disposed in a liquid flow path, comprising:
a main body portion having a bottom part and a side wall part standing upward from the bottom part, so as to store liquid in a containing region defined as a region enclosed by the bottom part and the side wall part;
a lid portion attached to the main body portion so as to cover the containing region from above;
a liquid flow inlet configured to allow the liquid to flow into the containing region;
a liquid flow outlet configured to allow the liquid to flow out from the containing region to a feed destination; and
a bubble exhaust port configured to discharge bubbles in the containing region, wherein
the liquid flow inlet, the liquid flow outlet, and the bubble exhaust port are all disposed in the lid portion.

2. The liquid container according to claim 1, wherein
the liquid flow inlet, the liquid flow outlet, and the bubble exhaust port respectively have outer cylinder parts, which each protrude upward from the lid portion in a cylindrical manner, and
the outer cylinder parts are respectively connected to conduits in which liquid flows.

3. The liquid container according to claim 1,
an opening of the bubble exhaust port on the containing region side is disposed at a position more apart from the bottom part than an opening of each of the liquid flow inlet and the liquid flow outlet on the containing region side.

4. The liquid container according to claim 1,
an opening of the liquid flow outlet on the containing region side is disposed at a position closer to the bottom part than an opening of the liquid flow inlet on the containing region side.

5. The liquid container according to claim 4, wherein
the liquid flow outlet has an inner cylinder part protruding downward from the lid portion in a cylindrical manner, so as to be disposed in the containing region, and allows the liquid flowing in through a lower end opening of the inner cylinder part to flow out to the feed destination.

6. An inkjet recording device comprising:
the liquid container according to claim 1;
an ink storage container configured to store ink; and
a recording head, wherein
the liquid container stores ink flowing in from the ink storage container, and
the recording head forms an image on a sheet using the ink fed from the liquid container.
